(19) United States
(12) Patent Application Publication
(10) Pub. No.: US 2011/0183724 A1
(43) Pub. Date: Jul. 28, 2011

(54) GENERATION OF VIDEO CLIPS FROM A FRIEND'S RECENT SOCIAL STREAM

(76) Inventors: JONATHAN WILLIAM MEDVED, Jerusalem (IL); David Elliot Goldfarb, Bet Shemesh (IL)

(21) Appl. No.: 13/014,805

(22) Filed: Jan. 27, 2011

Related U.S. Application Data
(60) Provisional application No. 61/298,933, filed on Jan. 28, 2010.

(51) Int. Cl. H04B 1/38

(52) U.S. Cl. 455/567

(57) ABSTRACT

A method for playing ringtones on a user's communications device includes requesting a media ringtone to be generated from at least a media stream of a friend, where the media stream is accessible to the user via a social network, receiving the media ringtone on the device, associating the media ringtone with said friend; and playing the media ringtone upon an occasion of a communications related triggering event between the user and the friend.

### CROSS-REFERENCE TO RELATED APPLICATIONS

This application claims benefit from U.S. Provisional Patent Application No. 61/298,933, filed Jan. 28, 2010, which is incorporated herein by reference in its entirety.

### FIELD OF THE INVENTION

The present invention relates to social networks generally and to generation of a video clips from a friend's recent social stream in particular.

### BACKGROUND OF THE INVENTION

Social Networks, such as Facebook (http://www.facebook.com), typically allow users to create a stream of pictures, texts, and other media to represent what they are doing and what has caught their interest. For example, on Facebook, the “News Feed”, “Live Feed”, and “Wall” all offer different views of this stream of user activities.

Social networks also allow users to share these media streams with their friends on the same network, allowing them to watch and enjoy what's happening to each other. It will be appreciated that in order to view these streams, the friends typically have to login to the social network. Without this volitional effort, they cannot see their friends' media streams.

In order to make these streams more visible, users can register to receive emails anytime their friends “change their status” or otherwise change their stream.

Recently, some mobile handset manufacturers and operators have made these streams visible on the handset “home screen”. Notable examples are Motorola's MotoBlur (http://www.motorola.com/Consumers/US-EN/Consumer-Product-and-Services/MOTOBLUR/Meet-MOTOBLUR) and Vodafone's Vodafone 360 Live (http://www.vodafone.com/start/media_relations/news/group_press releases/2009/360.html).

These systems use the handset home screen to present key elements of the social streams.

### SUMMARY OF THE INVENTION

There is provided, in accordance with a preferred embodiment of the present invention, a method for playing ringtones on a user's communications device, including requesting a media ringtone to be generated from at least a media stream of a friend, where the media stream is accessible to the user via a social network, receiving the media ringtone on the device, associating the media ringtone with the friend, and playing the media ringtone upon an occasion of a communications related triggering event between the user and the friend.

Further, in accordance with a preferred embodiment of the present invention, the requesting also includes storing login details for the user, and providing the login details to the social network to access the media stream without input from the user.

Still further, in accordance with a preferred embodiment of the present invention, the method also includes periodically performing the receiving and associated of the requested media ringtone, and storing the received media ringtone on the user's communication device to facilitate the playing with minimal delay.

Additionally, in accordance with a preferred embodiment of the present invention, the method also includes delaying the playing in accordance with a duration required to perform the requesting, receiving and associating, where the user is not otherwise alerted regarding the communications related triggering event during the delaying.

Moreover, in accordance with a preferred embodiment of the present invention, the playing includes playing a default ringtone stored on the user's communications device in addition to the playing of the media ringtone.

Further, in accordance with a preferred embodiment of the present invention, the default ringtone is associated with the friend.

Still further, in accordance with a preferred embodiment of the present invention, the playing a default ringtone is performed prior to the playing of the media ringtone, and the default ringtone is of a duration consistent with a length of time required to perform the requesting, receiving and associating prior to the playing of the media ringtone.

Additionally, in accordance with a preferred embodiment of the present invention, the playing a default ringtone is performed at least partly in parallel with the playing of the media ringtone.

Moreover, in accordance with a preferred embodiment of the present invention, the triggering event is at least one of an incoming call, an outgoing call, an ongoing call, an end of a call, and an SMS alert.

Further, in accordance with a preferred embodiment of the present invention, the method also includes generating the media ringtone on the device from the media stream accessed via the social network.

Still further, in accordance with a preferred embodiment of the present invention, the method also includes periodically polling the social network to check for changes in the media stream, and performing the requesting when the changes in the media stream are detected.

Additionally, in accordance with a preferred embodiment of the present invention, the method also includes configuring the polling to be performed by an external polling server.

Moreover, in accordance with a preferred embodiment of the present invention, the requesting is in response to a notification received from the social network, where the notification indicates that a change has occurred in the media stream.

There is also provided, in accordance with a preferred embodiment of the present invention, a method for generating ringtones to be played on a user's communications device, including receiving a request from the user to generate a ringtone from at least a friend's media stream, where the media stream is accessible to the user via a social network, generating the ringtone from at least the media stream, and downloading the generated ringtone to the user's communications device associated with the user with at least an indication that at least the generated ringtone is to be played upon the occasion of a communications related triggering event between the user and the friend.

Further, in accordance with a preferred embodiment of the present invention, the method also includes periodically polling the social network to check for changes in the media stream, where the generating is performed when the changes in the media stream are detected.

There is also provided, in accordance with a preferred embodiment of the present invention, a user's communications device including a social stream media requestor to request generation of a media ringtone, the media ringtone to be generated from at least a media stream associated with a friend of the user, a media ringtone manager to associate the media ringtone with at least one communications event involving a friend's communication device associated with the friend, and a media player to play the media ringtone upon the occasion of the communications event.

There is also provided, in accordance with a preferred embodiment of the present invention, a media clip generator including means for receiving a request from a user to generate a media ringtone, the media ringtone to be generated from at least a media stream associated with a friend of the user, a social stream interface to at least access and receive the media stream from a social network, where the user and the friend are associated with each other on the social network, a clip generation utility to generate the media ringtone from at least the media stream, and means for providing the media ringtone to a communications device associated with the user.

Further, in accordance with a preferred embodiment of the present invention, the media clip generator is implemented on the device.

Still further, in accordance with a preferred embodiment of the present invention, the media clip generator is implemented on a server with access to the communications device and the social network via the Internet.

Additionally, in accordance with a preferred embodiment of the present invention, the server is also a community server for members of a media sharing community, where the user and the friend are among the members and are also defined within the community as “buddies” that share media content with each other.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a novel video ringtone generation and distribution system 100, constructed and operative in accordance with a preferred embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The prior art has several disadvantages when viewing a user's media stream. For example, as disclosed hereinabove, the friends may typically have to proactively login to the social network to view the stream. Even then, there may be additional issues to deal with. Depending on the view selected, different media streams may be displayed together as a single amalgamated stream. Alternatively, the friends may have to search for a particular stream of interest by selecting a particular user of interest. It will be appreciated that it is not uncommon for a user to have hundreds and even thousands of friends. In such circumstances, keeping track of individual media streams may be an extremely daunting task.

The solutions provided by mobile handset manufacturers and operators may also be problematic. Simultaneous presentation of individual media streams may suffer from the size constraints of a typical mobile display. Amalgamated media streams may be difficult to follow, and presentation of multiple friends' media streams may take too long, or be too confusing. A handset's home screen is generally not large enough to display multiple social streams, representing all of a user's friends. Instead, selection must be made, showing only some events, typically the most recent, of a small handful of friends.

Applicant has realized that users may be interested in seeing the streams of different users at different times. Applicant has also realized that users may prefer to see a friend's media stream at the start of a communication event with that friend. Accordingly, it may be advantageous to associate the display of a friend's social network originated media stream with a call occurring between the user and the friend. For example, when a friend calls a user, the user may view an extract from the friend's media stream on the user's communication device's display. At the same time, the friend may view the user's media stream on the friend's communication device's display.

U.S. Pat. No. 7,761,816, assigned to the common assignee of the present invention and hereby incorporated in its entirety by reference, defines a video ringtone in which the video clip is chosen by the calling party, to be displayed on the called handset. U.S. Pat. No. 7,761,816 also discloses a community server that may facilitate the distribution of a user's selected/provided video ringtone to his/her “friends”. U.S. patent application Ser. No. 11/768,989, also assigned to the common assignee of the present invention and also incorporated in its entirety by reference, describes methods for user-generation of video clips for the various types of ringtones.

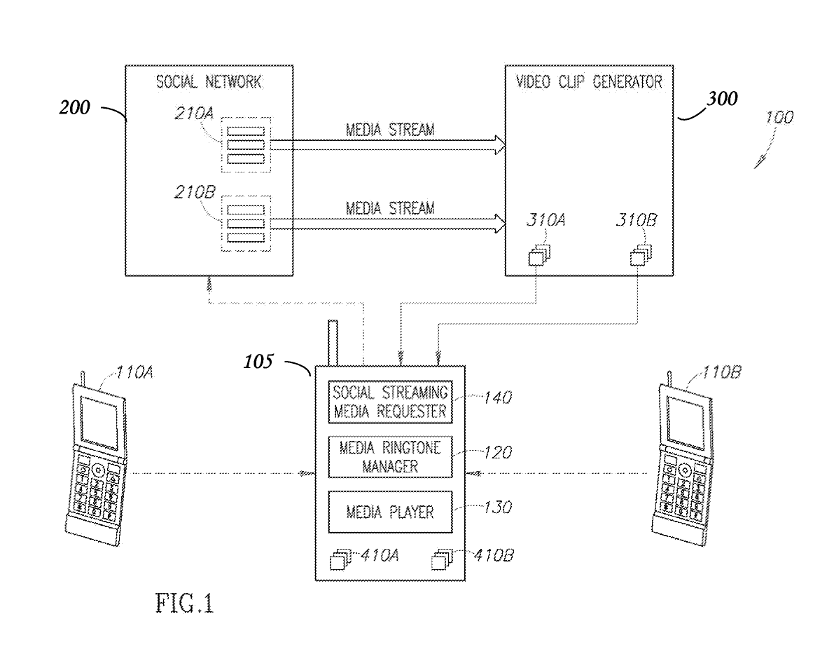

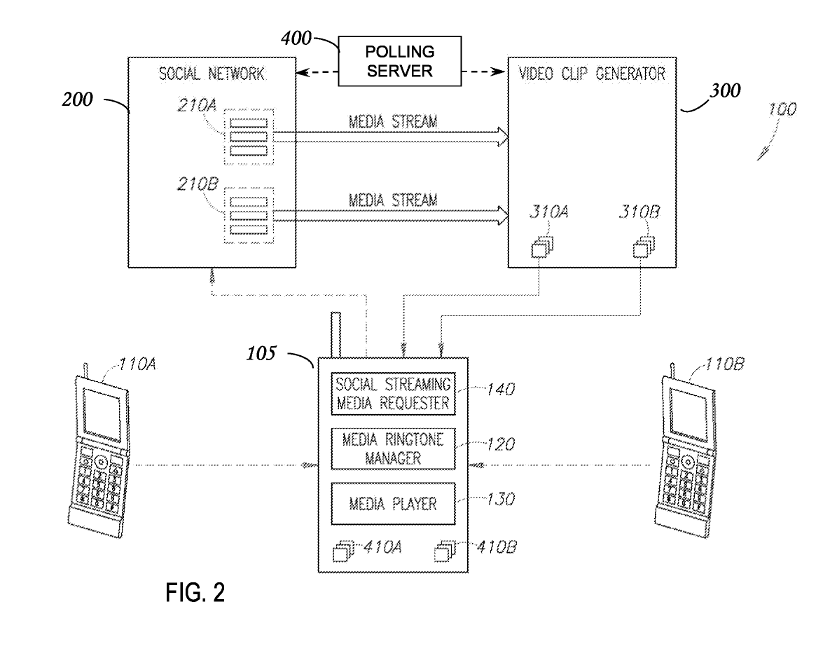

Reference is now made to FIG. 1 which illustrates a novel video ringtone generation and distribution system 100, constructed and operative in accordance with a preferred embodiment of the present invention. System 100 may comprise a social network 200, a video clip generator 300 and a communications device 105 belonging to a user of social network 200. Communications devices 110 may be used by friends of the user to communicate with device 105.

Communications device 105 may comprise a media ringtone manager 120 and a media player 130. Manager 120 may facilitate the playing of media ringtones on media player 130 in response to communications triggering events associated with the user's friends, such as those using devices 110. Manager 120 may function in a generally analogous manner to the method and system disclosed in U.S. Pat. No. 7,761,816 and U.S. patent application Ser. No. 11/768,989; however it will be appreciated that the invention may include any such suitable media ringtone management function.

Communications device 105 may also comprise media stream requester 140. Media stream requester 140 may, as will be described hereinbelow, initiate and/or control a process for converting a friend's media stream to a media ringtone to be associated with that particular friend. In accordance with a preferred embodiment of the present invention, media stream requester 140 may be configured to initiate this process on a periodic basis. Alternatively, the user may activate requester 140 on demand.

Social network 200 may have stored media streams 210 associated with friends of user 10. It will be appreciated that media streams 210 may comprise at least one of a variety of types of media content, such as: images, text, video clips, audio clips and data/application files. Requester 140 may forward a request to social network 200 for media streams associated with friends of the user of device 105 to be forwarded to, or read by, video clip generator 300. In an exemplary preferred embodiment of the present invention, media stream 210A may be associated with the friend using communications device 110A; media stream 2108 may be similarly associated with the friend using device 1108.

It will be appreciated that social network 200 may typically have available application programmer interfaces (APIs) that may enable third-party developers to access and manipulate social streams on behalf of a user. For example, the APIs for Facebook may be available at http://developers.facebook.com/. These APIs may typically allow an application to login as the user to the social network server. In this role, an application such as requester 140 may request the media streams of the user's friends, as would they would normally be presented to the user by social network 200. Security issues and filtering may thus be typically handled by social network 200. It will be appreciated that additional filtering may also be implemented within the context of the present invention, to meet the needs of presentation, formatting, privacy, or any other criteria.

Video clip generator 300 may be any suitable application or service for the generation of a video clip from a media stream. For example, Animoto, available at http://animoto.com/, may be used to generate video clips from media streams of individual images, music, and text. Video clip generator 300 may generate video clips 310 for download to device 105 as video ringtones 410, on behalf of the user of device 105.

Accordingly, as per the exemplary embodiment illustrated in FIG. 1, requester 140 may initiate the generation of video clip 310A from media stream 210A associated with the user's friend that may be associated with device 110A. Video clip 310A may be downloaded for use on device 105 as media ringtone 410A. Upon the occasion of a communications triggering event involving device 110, media player 130 may play associated media ringtone 410A. Similarly, if a communications triggering event may involve device 110B, media ringtone 410B may be played.

It will be appreciated that communication devices 110 may be any suitable devices for communicating with device 105. Accordingly, it will be appreciated that devices 110 may or may not be configured in a similar manner as device 105. The present invention may also include embodiments wherein the friends associated with media streams 110 may also be using devices 105. Similarly it will be appreciated that the embodiment depicting a user with two friends is exemplary; system 100 may be configured to process any relevant number of friends.

It will further be appreciated that in accordance with the disclosed prior art, a friend or “buddy” of a user may typically select/provide a media clip and “push” it to the user on whose device it may eventually be played as a media ringtone. In contrast, the present invention may disclose a method for a user to “pull” content about the friend/buddy without proactive selection/provision of a media clip by the friend/buddy. The only action required by the friend/buddy may be to accept the user as a friend within the context of social network 200.

In accordance with an alternative preferred embodiment of the present invention, video clip generator 300 may be replaced (or alternatively, augmented) by a photo montage tool that may generate a photo montage comprising multiple photos and/or texts to be displayed all at the same time. A tool such as ImageMagick, available at http://www.imagemagick.org, may be used, for example, to generate the montage.

In accordance with another alternative preferred embodiment, social stream requester 140 may be implemented as a module on a community server for media sharing, such as the community server disclosed in U.S. patent application Ser. Nos. 11/544,938 and 11/768,989. The user of device 105 may access this module to configure preferences for the downloading of media ringtones. In accordance with an alternative embodiment of the present invention, video clips 310 may be temporarily stored on such a community server prior to their distribution to device 105 as disclosed in U.S. patent application Ser. Nos. 11/544,938 and 11/768,989.

In accordance with a preferred embodiment of the present invention, in order to distinguish the “ringing” device as belonging to user 10, the user may elect to define an audio track to be played in parallel with video ringtone 410. The audio and video streams may be played simultaneously on device 105 or they may be combined into a single audiovisual stream by video clip generator 300.

In accordance with a preferred embodiment of the present invention, the video ringtone may also be implemented as any other tone of the mobile device, such as a ringback tone played to the caller, ringback tone played at the end of call, SMS arrival tone signifying the arrival of a text message, etc.

In accordance with a preferred embodiment of the present invention, video clip generator 300 may also be installed on device 105.

In accordance with a preferred embodiment of the present invention, video clip generator 300 may be included as a module on a server, such as the community server disclosed in U.S. patent application Ser. Nos. 11/544,938 and 11/768,989.

In accordance with a preferred embodiment of the present invention, requester 140 may be configured to download to and cache media ringtones 410 on device 105 at regular time intervals.

In accordance with a preferred embodiment of the present invention, requester 140 may be configured to poll media streams 210 on a frequent basis and to initiate the generation of a new video ringtone 310 for download to device 105 as video ringtone 410 whenever a change is detected in a media stream 210.

It will be appreciated that frequent polling may be problematic on a battery operated device such as device 105. Reference is now made to FIG. 2. In accordance with a preferred embodiment of the present invention, system 100 may be configured with a polling server 400 that may act on behalf of the user of device 105 to periodically poll social network 200 for changes in media streams 210. When such changes may be detected, polling server 400 may alert generator 300 to begin the generating an updated version of video ringtone 310 as discussed hereinabove. Alternatively, polling server 400 may send notify requester 140, after which requester 140 may initiate generation of video ringtones 310/410 as described hereinabove. It will be appreciated that polling server 400 may be implemented in combination with, or separately from, generator 300.

Some social networks 200 may have functionality for automatically notifying a user regarding changes in a friend's media stream 210. In such a case, social network 200 may configured to “push” notification of a change to device 105 via any suitable means, such as, for example, SMS, TCP, or Platform-specific services, such as, for example, Apple Push Notification Service on iPhones.

Upon receipt of a notification from the social network or polling server, requester 140 may then initiate the generation of a new video ringtone 410 as discussed hereinabove.

In accordance with a preferred embodiment of the present invention, video ringtone 410 may be requested and generated in real-time as part of the start of the call handling process on device 105. This may be done directly by the process implementing the call-handling ringtone, or an asynchronous request may trigger social stream media requestor 140. The request response, when it arrives, may replace or augment the ongoing ringtone. It will be appreciated that the user receiving the incoming call may typically be unaware of its existence before a ringtone may start to play. Accordingly, a slight delay, that may be necessary in order to generate and download the requested ringtone, may be unnoticed by the user. Alternatively, a default or previously generated ringtone may be played immediately without delay, and the newly generated ringtone may then replace or augment it.

The request response may even arrive after the ringtone has completed or the call has been answered. In accordance with a preferred embodiment of the present invention, the video stream may be played silently on the screen during the call conversation.

In accordance with a preferred embodiment of the present invention, video ringtone 410 may be streamed to device's 110 during call-handling, or during the call conversation or at any other suitable time, and may be played from the streaming input, rather than being pre-cached.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a computer, computing system, or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer. Such a computer program may be stored in a computer readable storage medium, such as, but not limited to, any type of disk, including floppy disks, optical disks, magnetic-optical disks, read-only memories (ROMs), compact disc read-only memories (CD-ROMs), random access memories (RAMs), electrically programmable read-only memories (EPROMs), electrically erasable and programmable read only memories (EEPROMs), magnetic or optical cards, Flash memory, or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method for playing ringtones on a user's communications device, the method comprising:
requesting a media ringtone to be generated from at least a media stream of a friend, wherein said media stream is accessible to said user via a social network;
receiving said media ringtone on said device;
associating said media ringtone with said friend; and
playing said media ringtone upon an occasion of a communications related triggering event between said user and said friend.

2. The method according to claim 1 and wherein said requesting also comprises:
storing login details for said user; and
providing said login details to said social network to access said media stream without input from said user.

3. The method according to claim 1 and also comprising:
periodically performing said receiving and associated of said requested media ringtone; and
storing said received media ringtone on said user's communication device to facilitate said playing with minimal delay.

4. The method according to claim 1 and also comprising:
delaying said playing in accordance with a duration required to perform said requesting, receiving and associating, wherein said user is not otherwise alerted regarding said communications related triggering event during said delaying.

5. The method according to claim 1 and wherein said playing comprises:
playing a default ringtone stored on said user's communications device in addition to said playing of said media ringtone.

6. The method according to claim 5 and wherein said default ringtone is associated with said friend.

7. The method according to claim 5 and wherein said playing a default ringtone is performed prior to said playing of said media ringtone, and said default ringtone is of a duration consistent with a length of time required to perform said requesting, receiving and associating prior to said playing of said media ringtone.

8. The method according to claim 5 and wherein said playing a default ringtone is performed at least partly in parallel with said playing of said media ringtone.

9. The method according to claim 1 and wherein said triggering event is at least one of an incoming call, an outgoing call, an ongoing call, an end of a call, and an SMS alert.

10. The method according to claim 1 and also comprising:
generating said media ringtone on said device from said media stream accessed via said social network.

11. The method according to claim 1 and also comprising:
periodically polling said social network to check for changes in said media stream; and
performing said requesting when said changes in said media stream are detected.

12. The method according to claim 11 and also comprising configuring said polling to be performed by an external polling server.

13. The method according to claim 1 and wherein said requesting is in response to a notification received from said social network, wherein said notification indicates that a change has occurred in said media stream.

14. A method for generating ringtones to be played on a user's communications device, the method comprising:
receiving a request from said user to generate a ringtone from at least a friend's media stream, wherein said media stream is accessible to said user via a social network;
generating said ringtone from at least said media stream; and
downloading said generated ringtone to said user's communications device associated with said user with at least an indication that at least said generated ringtone is to be played upon the occasion of a communications related triggering event between said user and said friend.

15. The method according to claim 14 and also comprising:
periodically polling said social network to check for changes in said media stream, wherein said generating is performed when said changes in said media stream are detected.

16. A user's communications device comprising:
a social stream media requestor to request generation of a media ringtone, said media ringtone to be generated from at least a media stream associated with a friend of said user;
a media ringtone manager to associate said media ringtone with at least one communications event involving a friend's communication device associated with said friend; and
a media player to play said media ringtone upon the occasion of said communications event.

17. A media clip generator comprising:
means for receiving a request from a user to generate a media ringtone, said media ringtone to be generated from at least a media stream associated with a friend of said user;
a social stream interface to at least access and receive said media stream from a social network, wherein said user and said friend are associated with each other on said social network;
a clip generation utility to generate said media ringtone from at least said media stream; and
means for providing said media ringtone to a communications device associated with said user.

18. The media clip generator according to claim 30 and wherein said media clip generator is implemented on said device.

19. The media clip generator according to claim 30 and wherein said media clip generator is implemented on a server with access to said communications device and said social network via the Internet.

20. The media clip generator according to claim 32 and wherein said server is also a community server for members of a media sharing community, wherein said user and said friend are among said members and are also defined within said community as “buddies” that share media content with each other.
